(19) United States
(12) Patent Application Publication
(10) Pub. No.: US 2006/0215196 A1
(43) Pub. Date: Sep. 28, 2006

(54) Print control method in a print control apparatus that controls a print apparatus provided with a plurality of paper-feed devices

(75) Inventor: Masahiro Someno, Nagano-ken (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/387,562

(22) Filed: Mar. 22, 2006

(30) Foreign Application Priority Data
Mar. 24, 2005 (JP) 2005-85938
Mar. 17, 2006 (JP) 2006-73973

(51) Int. Cl. G06K 15/00

(52) U.S. Cl. 358/1.12; 358/498

(57) ABSTRACT

A print control method in a print control apparatus that controls a print apparatus provided with a plurality of paper-feed devices. The method comprises judgment processing in which a type of a printing object is judged, acquisition processing in which a type of paper set in each paper-feed device of said print apparatus is acquired, and selection processing in which a paper-feed device to be used is selected based on the type of the printing object judged in said judgment processing and the paper type acquired in said acquisition processing. This method can reduce time and effort to designate a paper-feed device suitable for a printing object.

The entire disclosure of Japanese Patent Applications Nos. 2005-85938 filed Mar. 24, 2005 and 2006-73973 filed Mar. 17, 2006 are expressly incorporated by reference herein.

### BACKGROUND OF THE INVENTION

The present invention relates to a print system comprising a print apparatus and a print control apparatus, and in particular to a paper-feed control technique suitable for a print apparatus provided with a plurality of paper-feed slots.

Recently, print apparatuses developed for personal and family uses have been improved in their print quality, and thus come to be used also for so-called photo printing. For such photo printing, photo paper, i.e. paper exclusively used for photo printing, is frequently used instead of plain paper used for general printing.

In that case, a user needs to change sheets of paper set in an automatic paper-feed device depending on a purpose of printing. To save time for this, there is proposed a print apparatus provided with a plurality of paper-feed devices, among which one paper-feed device feeds plain paper exclusively and the other paper-feed devices can feed various types of paper such as photo paper.

In such a print apparatus, to print a photograph, a user designates a paper-feed device in which photo paper is set. And, to print a document mainly composed of text, the user designates a paper-feed device in which plain paper is set.

Thus, a user should properly designate a paper-feed device suitable for an object of printing, and this takes time and effort.

### SUMMARY OF THE INVENTION

An object of the present invention is to reduce time and effort to designate a paper-feed device suitable for an object of printing.

To attain the object, the present invention provides a print control method in a print control apparatus that controls a print apparatus provided with a plurality of paper-feed devices. This print control method comprises: judgment processing in which a type of a printing object is judged; acquisition processing in which a type of paper set in each paper-feed device of the print apparatus is acquired; and selection processing in which a paper-feed device to be used is selected based on the type of the printing object judged in the judgment processing and the paper type acquired in the acquisition processing.

According to the present invention, a type of a printing object is judged, and a paper-feed device to be used is selected based on the type of paper set in the print apparatus. As a result, it is possible to reduce time and effort to designate a paper-feed device suitable for the printing object.

### BRIEF DESCRIPTION OF THE DRAWINGS

FIG. 1 is a block diagram for explaining an outline of a hardware configuration of a print system;

FIG. 2 is a schematic view for explaining an outlined cross section of a printer;

FIG. 3 is a schematic view for explaining paper feeding and ejecting mechanisms of a printer;

FIG. 4 is a block diagram showing a functional configuration of a computer;

FIG. 5 is a view showing an example of a print setting screen;

FIG. 6 is a flowchart for explaining processing by a printer driver part;

FIG. 7 is a flowchart for explaining an example of processing of selecting a paper-feed device used for printing;

FIG. 8 is a view showing a screen that displays a selected paper-feed device and prompts user's confirmation;

FIG. 9 is a flowchart for explaining another example of processing of selecting a paper-feed device used for printing; and

FIG. 10 is a view showing a screen that instructs a user to change paper.

### DETAILED DESCRIPTION

Now, embodiments of the present invention will be described referring to drawings.

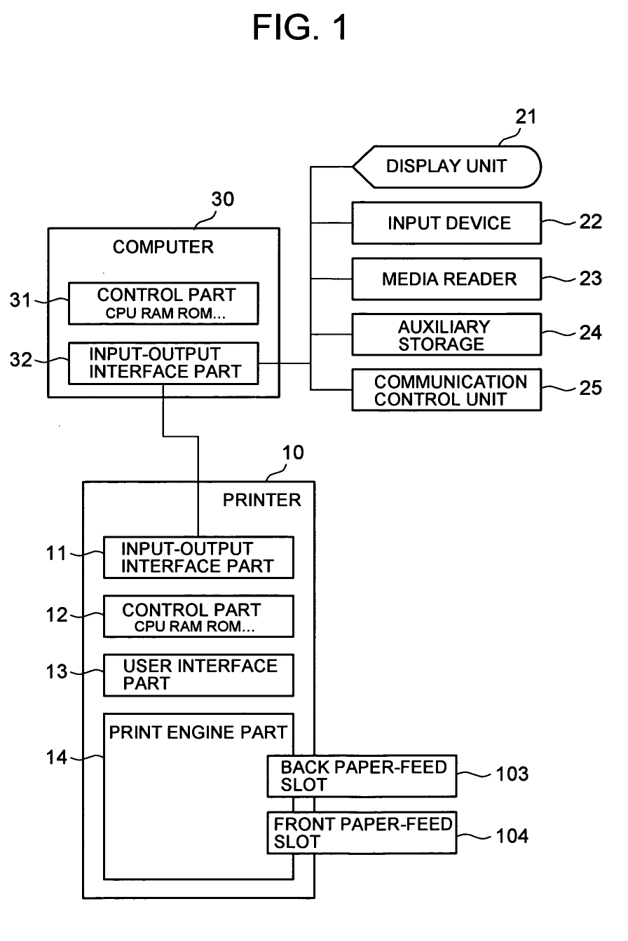

FIG. 1 is a block diagram for explaining an outline of a hardware configuration of a print system to which the present invention has been applied.

As shown in the figure, the print system comprises a computer 30 and a printer 10 connected to the computer 10. The computer 30 executes various kinds of processing of application software, print processing of a printer driver, and other processing.

In the present embodiment, the computer 30 functions as a print control apparatus that generates print data, and sends the print data to the printer 10. Further, the printer 10 functions as a print apparatus that performs printing based on received print data.

Generally, a printer driver, which is a computer program for making the computer 30 function as a print control apparatus, is developed by a maker of the printer 10 in order to support the printer 10. Such a printer driver is distributed being recorded on a storage medium such as a CD-ROM, or through a computer network such as the Internet.

Configuration of the print system is not limited to this. For example, a print apparatus and a print control apparatus may be integrated into a print system. Or, a print system may be realized using a complex apparatus having multiple functions such as a reader function, a print function, and the like.

The computer 30 comprises a control part 31 and an input-output interface part 32. The control part 31 comprises: a CPU (Central Processing Unit) for executing various programs; a RAM (Random Access Memory) for temporarily storing data, programs and the like; a ROM (Read Only Memory) that stores various data, various programs and the like for controlling the computer 30; and the like. The input-output interface part 32 manages sending and receiving of data to and from peripheral devices connected to the input-output interface part 32.

Further, the computer 30 is connected with: a display unit 21 such as a color display; an input device 22 such as a mouse, a keyboard or the like; a media reader 23 for reading data from a record medium such as a CD-ROM; an auxiliary storage 24; a communication control unit 25 for connection to a computer network such as the Internet; and the like. Configuration of the computer 30, however, is not limited to this.

The printer 10 comprises: an input-output interface part 11 for communicating with the computer 30; a control part 12, which comprises a CPU, a RAM, a ROM and the like and controls various kinds of processing of the printer 10; a user interface part 13 for receiving an instruction from a user and for displaying a state and the like of the printer 10; and a print engine part 14, which comprises a print mechanism, paper feeding and ejecting mechanisms, and the like.

In the present embodiment, the print engine part 14 is provided with two paper-feed devices as paper feeding mechanisms. As described below, these paper-feed devices are provided in the back and the front of a casing of the printer 10, and referred to as a back paper-feed slot 103 and a front paper-feed slot 104 respectively. An instruction from the computer 30 determines which of these paper-feed devices will be used for feeding paper.

The printer 10 may be provided with three or more paper-feed devices. Further, as described below, the present invention can be applied to a case where a printer is provided with one paper-feed device only.

The printer 10 may be an ink-jet color printer. An ink-jet color printer is provided with a plurality of ink cartridges containing respective inks, and performs printing by blowing these inks against a print medium such as print paper through a plurality of nozzles provided in a print head. However, a laser printer may be used as the printer 10.

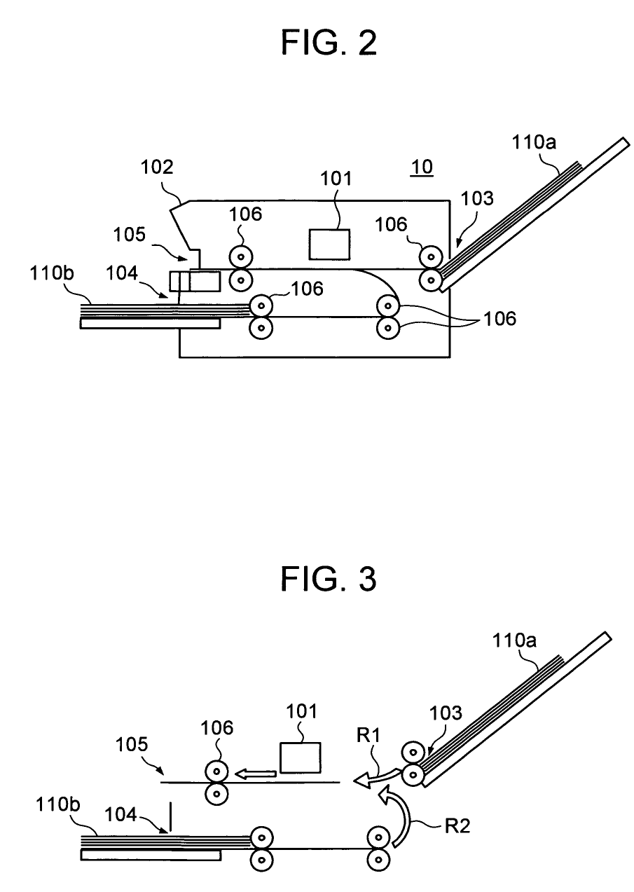

FIG. 2 is a schematic view for explaining an outlined cross section of the printer 10. As shown in the figure, the printer 10 is provided with two paper-feed devices, i.e. the back paper-feed slot 103 and the front paper-feed slot 104 set with print paper 110a and print paper 110 b respectively.

Print paper 110 is fed from the back paper-feed slot 103 or the front paper-feed slot 104 by means of a plurality of rollers 106. And, ink drops discharged from the print head provided in a carriage 101 carrying the ink cartridges forms an image on a print surface of the print paper 110. By means of the rollers 106, the printed paper 101 is ejected from an ejection slot 105 provided in the front of the casing.

The paper feeding mechanisms of the printer 10 are provided with paper type sensors in order to discriminate a type of paper set in each paper-feed slot. Here, it is assumed that plain paper and photo paper can be each discriminated as a paper type. Paper type sensors that can discriminate other types of paper may be used. As a method of discriminating a paper type, a conventionally-proposed technique such as discrimination by measuring a reflectance of paper or discrimination by measuring a thickness of paper may be employed.

Discrimination results of the paper type sensors are sent from the printer 10 to the computer 30 in response to a request from the computer 30.

Here, it is possible that, without providing paper type sensors, the printer 10 or the computer 30 receives a setting of a type of print paper set in each paper-feed slot from a user. Consequently, in any case, the computer 30 can acquire a type of print paper set in each paper-feed slot of the printer 10.

FIG. 3 is a schematic view for explaining paper feeding and ejecting mechanisms of the printer 10. As shown in the figure, in the present embodiment, the print paper 110a set in the back paper-feed slot 103 draws a large arc as shown by R1, to be fed toward the carriage 101. On the other hand, the print paper 110b set in the front paper-feed slot 104 draws a relatively small arc as shown by R2, to be fed toward the carriage 101. Print paper fed from either paper-feed slot is ejected from the ejection slot 105 by means of the rollers 106.

Accordingly, it is preferable that photo paper having larger thickness in comparison with plain paper is set in the back paper-feed slot 103 whose paper path has a larger arc shape so that a warp and the like of the paper become smaller. On the other hand, plain paper is slightly affected by the paper path having a small arc shape, and thus can be set in any of the back paper-feed slot 103 and the front paper-feed slot 104.

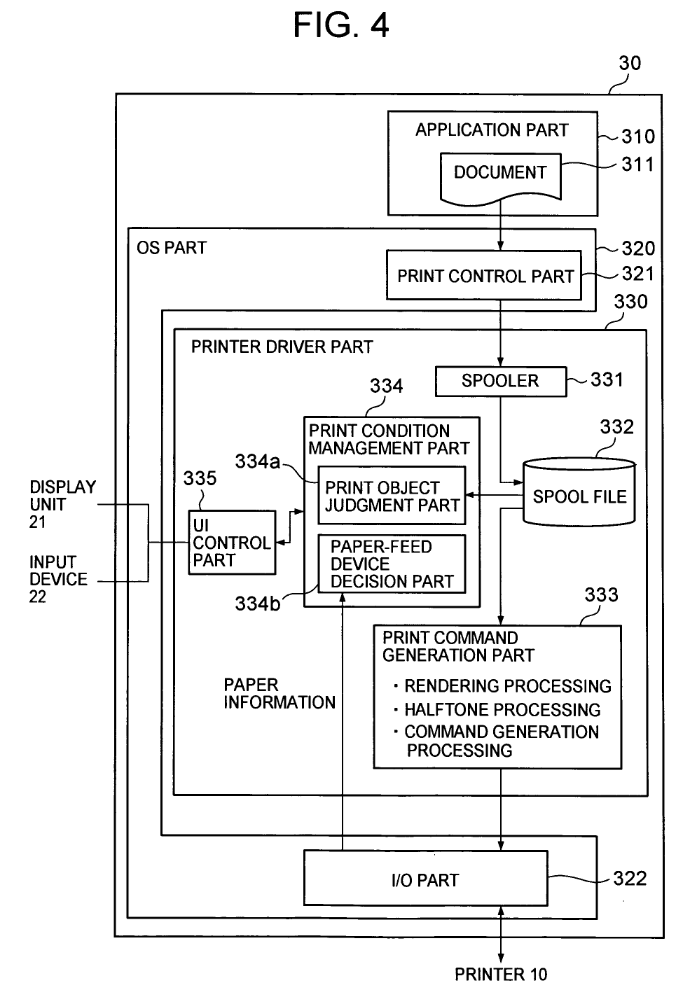

FIG. 4 is a block diagram showing a functional configuration of the computer 30 to which the present invention is applied.

As shown in the figure, the computer 30 comprises an application part 310, an operating system (OS) part 320 and a printer driver part 330.

The application part 310 has functions for making the computer 30 execute processing of a specific service such as a word processor, graphics, or the like. The application part 310 is realized on the computer 30 when the control part 31 executes an application program. The application part 310 stores a document 311 as an object of printing in this embodiment.

The OS part 320 comprises a print control part 321 and an I/O part 322. The print control part 321 manages operation of the printer driver part 330. And, the I/O part 322 outputs print data consisting of print commands to the printer 10, and receives input of information from the printer 10.

The printer driver part 330 comprises: a spooler 331 for storing rendering commands relating to the document 311 into a spool file 332; a print command generation part 333 for generating, based on the rendering commands stored in the spool file 332, print commands interpretable to the printer 10; a user interface (UI) control part 335 for controlling display on the display unit 21 and input from the input device 22; and a print condition management part 334 for managing print conditions sent from the user interface control part 335 and for acquiring information from the printer 10.

In the present embodiment, the print condition management part 334 comprises a print object judgment part 334a and a paper-feed device decision part 334b, as characteristic functional parts.

The print object judgment part 334a judges whether the document 311 as an object of printing is a photograph or a text document.

Here, a “photograph” means a document that mainly consists of image data expressed by bit map data, and a “text document” means a document that mainly consists of characters expressed by character codes and a graphic expressed by vector data. Although, in the present embodiment, it is judged whether the document 311 is a photograph or a text document, it is possible to judge only whether the document 311 is a photograph or not.

As a method of judging whether the document 311 is a photograph or a text document, various methods may be employed as shown by the following examples.

For example, the judgment may be made based on the type of the application part 310. Namely, when the application part 310 that has generated the document 311 is of the type working for a word processor, a spreadsheet or the like, then the document 311 is judged to be a text document. On the other hand, when the application part 310 is of the type working for album management, photo-retouching or the like, then the document 311 is judged to be a photograph.

Or, the document 311 may be judged based on the format of data constituting the document 311. Namely, when the document 311 mainly consists of character codes and vector data, then the document 311 is judged to be a text document. On the other hand, when the document 311 mainly consists of image data, the document 311 is judged to be a photograph.

In the case where character codes, vector data and image data coexist in the document 311, ratios between data amounts or area ratios between print results of these types of data may be calculated to judge whether the document 311 is a photograph or a text document.

Or, a preview image of the document 311 may be generated and the judgment may be made based on the resultant preview image. In this case, a part of the document 311 may be sampled and used for the judgment.

Or, the document 311 may be judged to be a photograph or a text document based on the number of colors, resolution and the like applied to printing of the document 311. Of course, the method of judging whether the document 311 is a photograph or a text document is not limited to these.

From the printer 10, the paper-feed device decision part 334b acquires the respective types of print paper set in the paper-feed slots of the printer 10. Then, the paper-feed device decision part 334b selects a paper-feed slot used for printing, based on the acquired paper types and the result of the judgment by the print object judgment part 334a on whether the document 311 is a photograph or a text document.

To this end, the paper-feed device decision part 334b can refer to a rule that associates a document type with a suitable print paper type. This rule may be stored within the paper-feed device decision part 334b or stored outside.

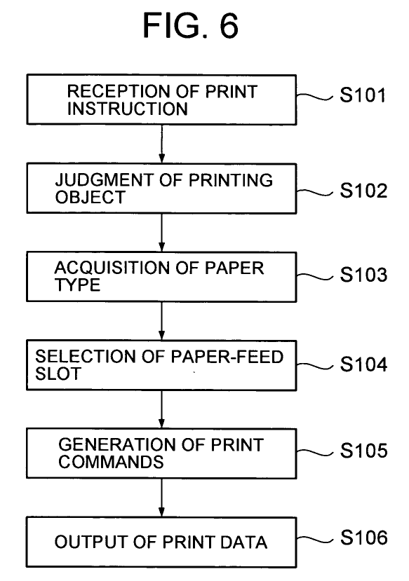

Next, processing characteristic of the printer driver part 330 will be described referring to a flowchart of FIG. 6 and other figures.

This processing is started when the printer driver part 330 receives an instruction to print the document 311, i.e. an object of the processing, from a user (S10).

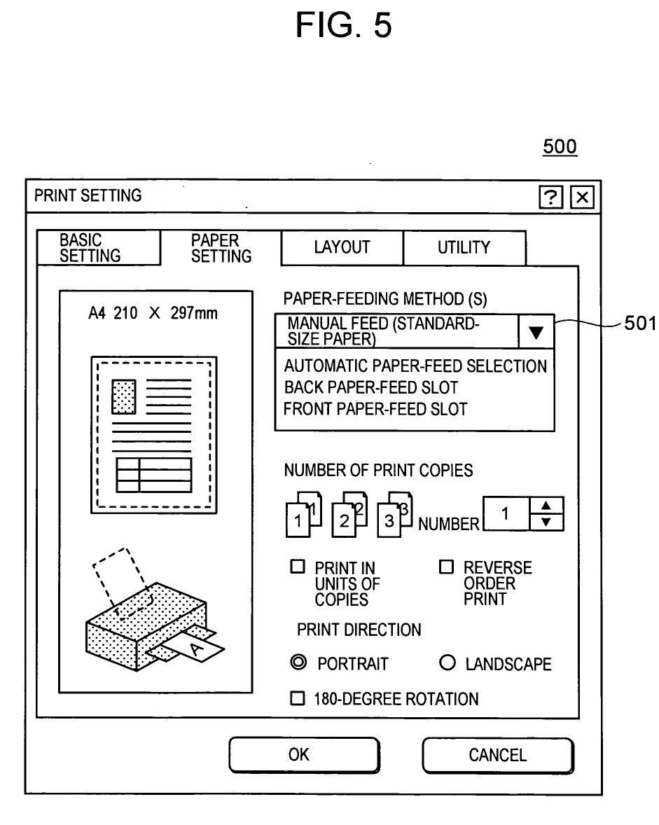

At the time of receiving a print instruction, the printer driver part 330 may receive print setting from the user. Print setting may be received through a print setting screen 500 as shown in FIG. 5, for example.

The print setting screen 500 is provided with an area 501 for receiving setting of a paper feeding method, in addition to areas for receiving setting of the number of print copies, a print direction and the like.

In the present embodiment, as shown in the figure, it is possible to designate “Automatic paper-feed selection” for selecting a paper-feed slot automatically, in the area 501 for receiving the setting of a paper feeding method. The following processing is performed when a user designates “Automatic paper-feed selection”. In other words, when a user designates “Back paper-feed slot” 103 or “Front paper-feed slot” 104, paper is fed through the back paper-feed slot 103 or the front paper-feed slot 104 of the printer 10 as designated by the user, irrespective of the type of paper set in each paper-feed device.

When a print instruction designating “Automatic paper-feed selection” is received, the print object judgment part 334a judges whether the document 311 as the object of printing is a photograph or a text document (S102). This judgment can be made using a method as described above.

Further, the paper-feed device decision part 334b acquires the type of print paper set in each paper-feed slot from the printer 10 (S103).

Then, the paper-feed device decision part 334b selects a paper-feed slot to be used for printing, based on the result of the judgment on whether the document 311 is a photograph or a text document and the print paper type acquired from the printer 10 (S104).

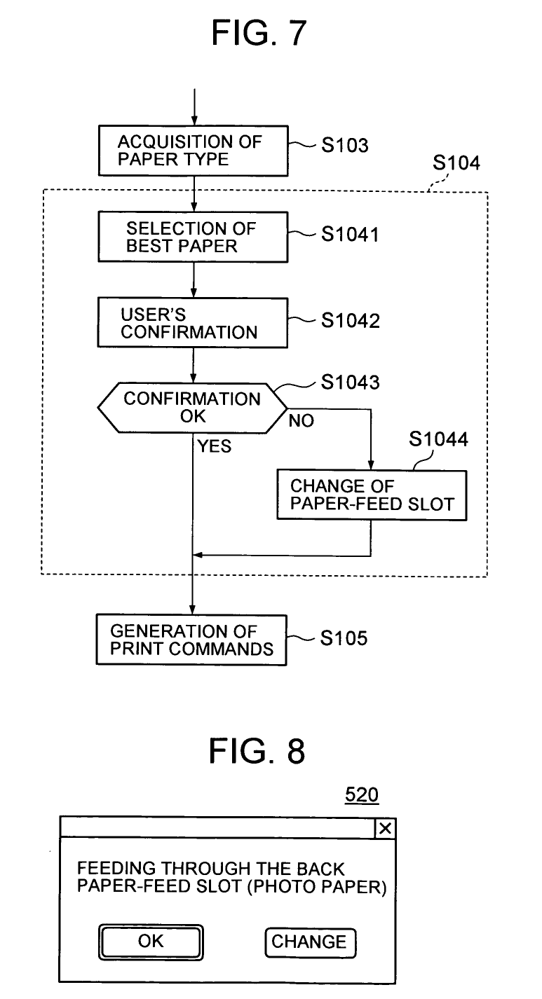

Referring to a flowchart of FIG. 7, will be described an example of the processing (S104) of selecting a paper-feed slot used for printing.

The paper-feed device decision part 334b selects the best paper among types of paper set in the printer 10, based on the result of the judgment on whether the document 311 is a photograph or a text document (S1041).

Namely, in the case where photo paper and plain paper are set in the printer 10, the paper-feed device decision part 334b selects the paper-feed slot in which photo paper is set, when the document 311 is judged to be a photograph. And, the paper-feed device decision part 334b selects the paper-feed slot in which plain paper is set, when the document 311 is judged to be a text document.

On the other hand, in the case where photo paper is not set in the printer 10 although the document 311 is judged to be a photograph, some type of paper set in the printer 10 is selected and the paper-feed slot in which that type of paper is set is selected. It has been previously determined which type of paper is to be selected in such a case. Similar processing is performed also in the case where plain paper is not set in the printer 10 although the document 311 is judged to be a text document.

Then, the selected paper-feed slot is displayed to prompt user's confirmation (S1042).

FIG. 8 is a view showing a screen 520 that displays the selected paper-feed slot and prompts user's confirmation. The user clicks the “OK” button when he acknowledges the displayed paper-feed slot. On the other hand, when the user wants change of the paper-feed slot, the user can click the “Change” button.

Receiving a click of the “OK” button (S1043: Y), the print condition management part 334 sets the print condition using the selected paper-feed slot for paper feeding. Then, the print command generation part 333 generates print commands of the document 311 in accordance with the print conditions (S105). And, the printer driver part 330 outputs the print commands, i.e. print data, to the printer 10 (S106).

On the other hand, receiving a click of the “Change” button (S1043: N), the print condition management part 334 sets the print condition using the non-selected paper-feed slot for paper feeding. Then, the print command generation part 333 generates print commands of the document 311 in accordance with the print conditions (S105). And, the printer driver part 330 outputs the print commands, i.e. print data, to the printer 10 (S106).

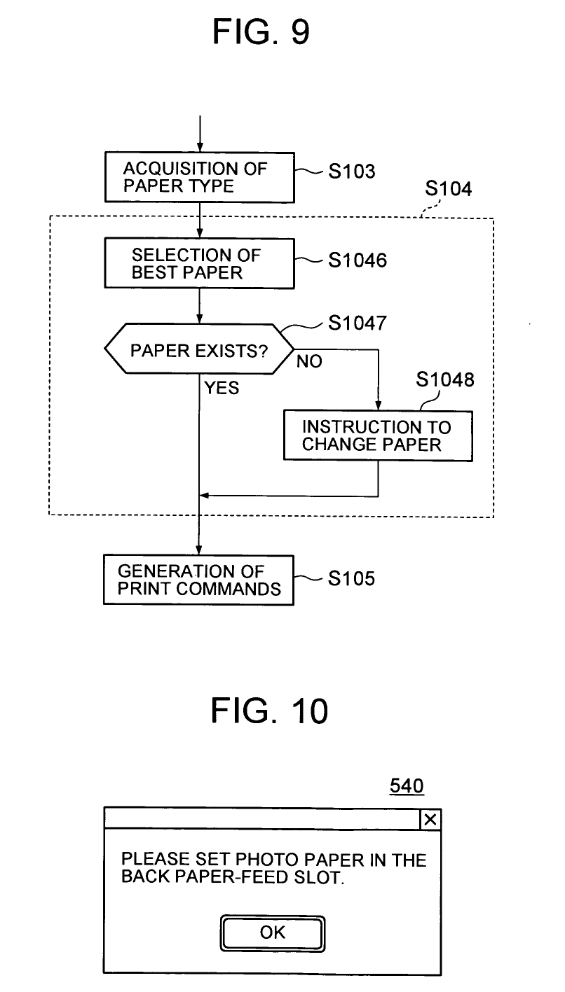

Next, another example of the processing (S104) of selecting a paper-feed slot to be used for printing will be described referring to a flowchart of FIG. 9.

The paper-feed device decision part 334b determines the best paper based on the result of the judgment on whether the document 311 is a photograph or a text document, irrespective of print paper set in the printer 10 (S1046). The present example is different from the above example in which the best paper is selected among the types of print paper set in the printer 10.

Namely, when the document 311 is judged to be a photograph, the paper-feed device decision part 334b determines photo paper as the best paper. On the other hand, when the document 311 is judged to be a text document, the paper-feed device decision part 334b determines plain paper as the best paper.

Then, the paper-feed device decision part 334b judges whether the determined print paper is set in the printer 10 (S1047).

As a result, when it is judged that the determined print paper is set in the printer 10 (S1047: Y), the print condition management part 334 sets paper feeding by the paper-feed slot in which the determined print paper is set. At that time, the paper-feed slot to be set may be displayed to prompt user's confirmation.

Then, the print command generation part 333 generates print commands of the document 311 in accordance with the print conditions (S105). And, the printer driver part 330 outputs the print commands, i.e. print data, to the printer 10 (S106).

On the other hand, when it is judged that the determined print paper is not set in the printer 10 (S1047: N), the print condition management part 334 instructs the user to change print paper (S1048).

FIG. 10 is a view showing a screen 540 that instructs a user to change paper. The example of the figure shows a case where the determined print paper is photo paper while photo paper is not set in the printer 10. Thus, the screen 540 for instructing change of paper displays a message “Please set photo paper in the back paper-feed slot”. Since it is favorable, as described above, that photo paper is set in the back paper-feed slot 103, the screen 540 instructs a user to set photo paper in the back paper-feed slot 103.

In the case where the determined print paper is plain paper while plain paper is not set in the printer 10, a message “Please set plain paper in the front paper-feed slot” may be displayed, for example.

In response, the user can change print paper as instructed and click the “OK” button. Here, it is also possible to click the “OK” button without change print paper.

Receiving a click of the “OK” button in the screen 540 instructing change of print paper, the print condition management part 334 sets paper feeding by the paper-feed device instructed. Then, the print command generation part 333 generates print commands of the document 311 in accordance with the print conditions (S105). And, the printer driver part 330 outputs the print commands, i.e. print data, to the printer 10 (S106).

In any case, when the printer 10 receives print data, the printer 10 feeds paper through the paper-feed slot designated by a paper-feed command included in the print data and performs printing based on the print data.

The example of processing explained referring to FIG. 9 can be applied to a case where the printer 10 is provided with only one paper-feed slot. In other words, the present invention can be applied not only to the case where the printer 10 is provided with a plurality of paper-feed devices and different types of paper are respectively set in those paper-feed devices, but also to the case where the printer 10 is provided with only one paper-feed slot.

The processing in the latter case will be described referring to FIG. 9 again.

In this example also, the paper-feed device decision part 334b acquires the type of print paper set in the paper-feed slot from the printer 10, in the processing of the step S103. In the above example, the type of print paper is acquired for each paper-feed slot. In the present embodiment, the printer 10 is provided with only one paper-feed slot, and accordingly one type of print paper is acquired.

The paper-feed device decision part 334b determines the best paper based on the result of the judgment on whether the document 311 is a photograph or a text document (S1046).

Namely, when the document 311 is judged to be a photograph, it is judged that photo paper is the best paper. On the other hand, when the document 311 is judged to be a text document, it is judged that plain paper is the best paper.

Then, the paper-feed device decision part 334b judges whether the determined print paper is set in the printer 10 (S1047).

As a result, when it is judged that the determined print paper is set in the printer 10 (S1047: Y), the print condition management part 334 continues the print processing. At that time, the determined print paper may be displayed to prompt user's confirmation. For example, a message “Photo paper set in the printer will be fed” may be displayed.

Then, the print command generation part 333 generates print commands of the document 311 in accordance with the print conditions (S105). And, the printer driver part 330 outputs the print commands, i.e. print data, to the printer 10 (S106).

On the other hand, when it is judged that the determined print paper is not set in the printer 10 (S1047: N), the print condition management part 334 instructs the user to change print paper (S1048). For example, a message “Please set photo paper” may be displayed. Thereafter, it is possible to make the paper-feed decision part 334 judge whether paper set by the user conforms to the determined paper, in the processing of the step S1047 again.

When the user responses to the instruction to change paper, the print condition management part 334 continues the print processing. Then, the print command generation part 333 generates print commands of the document 311 in accordance with the print conditions (S105). And, the printer driver part 330 outputs the print commands, i.e. print data, to the printer 10 (S106).

As a variant, the following processing may be performed based on the result of the judgment on whether the document 311 is a photograph or a text document in the processing of the step S102.

For example, it is possible to set print quality automatically based on the result of the judgment on whether the document 311 is a photograph or a text.

The print setting screen 500 shown in FIG. 5 has another screen that is provided with an entry for receiving designation with respect to whether setting of print quality gives priority to finish or to print speed. It is arranged such that, when finish is preferred, it is possible to obtain high resolution and high quality print result.

Generally, when a photograph is to be printed, a high quality print result is expected in many cases. Thus, in this variant, when the document 311 as an object of printing is judged to be a photograph, a print condition giving priority to finish is automatically set.

On the other hand, in the case of a text document, it is considered that shorter print time is more preferable than high resolution print result. Thus, when the document 311 as an object of printing is judged to be a text document, a print condition giving priority to print speed is automatically set.

In these cases, contents of the automatic setting may be displayed to prompt user's confirmation. The present variant can reduce user's time and effort required for setting print conditions.

When a document 311 is a photograph, printing without providing a border on all sides of a sheet of print paper, i.e. so-called borderless printing, is performed in many cases.

Thus, when the document 311 as an object of printing is judged to be a photograph, a print condition for borderless printing may be automatically set. Or, it is possible to display a message asking the user whether borderless printing should be performed. Thus, user's time and effort can be reduced furthermore.

As another variant, when it is judged in the processing of the step S102 that the document 311 as an object of printing is a photograph and further it is judged that the determined print paper is not set in the printer 10, a list of paper types suitable for photo printing may be displayed. Then, the user selects a paper type from the list. And the print processing is performed taking the selected type of paper as the determined paper. Or, it is possible to judge whether the selected paper has been set, in the processing of the step S1047.

As another variant, names of paper types may be displayed to make the user select one, when it is found that a plurality of types of print paper suitable for printing are set in the printer 10 after it is judged whether the document 311 is a photograph or a text document and the types of print paper set in the paper-feed slots are acquired.

For example, when the document 311 is judged to be a photograph and glossy paper and mat paper both suitable for photo printing are set in a plurality of paper-feed slots of the printer 10, it is possible to display a list consisting of glossy paper and mat paper to receive designation of the type of print paper which should be used for printing.

1. A print control method in a print control apparatus that controls a print apparatus provided with a plurality of paper-feed devices, said print control method comprising:
judgment processing in which a type of a printing object is judged;
acquisition processing in which a type of paper set in each paper-feed device of said print apparatus is acquired; and
selection processing in which a paper-feed device to be used is selected based on the type of the printing object judged in said judgment processing and the paper type acquired in said acquisition processing.

2. A print control method according to claim 1, wherein:
said judgment processing judges whether the printing object is a photograph.

3. A print control method according to claim 2, wherein:
said selection processing selects a paper-feed device in which print paper for photo printing is set, when said judgment processing judges that the printing object is a photograph.

4. A print control method according to claim 2, wherein:
in said selection processing, when the printing object is judged to be a photograph in said judgment processing and print paper for photo printing is not set in said print apparatus, then a message prompting setting of print paper for photo printing is displayed.

5. A print control method according to claim 1, further comprising:
display processing in which a result of selection in said selection processing is displayed.

6. A print control method according to claim 1, wherein:
in said selection processing, when the type of printing object judged in said judgment processing and the paper types acquired in said acquisition processing satisfy predetermined conditions, a plurality of types of paper are displayed to prompt a user to select.

7. A print control method according to claim 2, further comprising:
print data generation processing in which print data for performing higher quality printing is generated when it is judged, in said judgment processing, that the printing object is a photograph, in comparison with printing performed when it is judged that the printing object is not a photograph.

8. A print control method according to claim 2, further comprising:
print data generation processing in which print data for performing printing without providing a border to a sheet of print paper is generated when it is judged, in said judgment processing, that the printing object is a photograph.

9. A print control method in a print control apparatus that controls a print apparatus provided with one or more paper-feed devices, said print control method comprising:
judgment processing in which a type of printing object is judged;
acquisition processing in which a type of paper set in each paper-feed device of said print apparatus is acquired; and
discrimination processing in which suitability of printing using paper of the types acquired in said acquisition processing is judged based on the type of the printing object judged in said judgment processing and the paper types acquired in said acquisition processing, and a predetermined correspondence rule, and a message prompting change to another type of paper is displayed when the printing using the acquired paper types is judged to be unsuitable.

10. A print system comprising a print control apparatus and a print apparatus provided with a plurality of paper-feed devices, wherein:
said print apparatus comprises a detection part for detecting a type of paper set in each paper-feed device; and
said print control apparatus comprises:
a judgment part for judging a type of a printing object;
an acquisition part for acquiring a type of paper set in each paper-feed device of said print apparatus; and
a selection part for selecting a paper-feed device to be used, based on the type of the printing object judged by said judgment part and the paper type acquired by said acquisition part.

11. A print system comprising a print control apparatus and a print apparatus provided with one or more paper-feed devices, wherein:
said print apparatus comprises a detection part for detecting a type of paper set in each paper-feed device; and
said print control apparatus comprises:
a judgment part for judging a type of a printing object;
an acquisition part for acquiring a type of paper set in each paper-feed device; and
a discrimination part for judging suitability of printing using the paper types acquired by said acquisition part, based on the type of the printing object judged by said judgment part, the paper types acquired by said acquisition part and a predetermined correspondence rule, and when it is judged that printing using the types of paper acquired by said acquisition part is not suitable, a message prompting change to another type of paper is displayed.

12. A print control apparatus that controls a print apparatus provided with a plurality of paper-feed devices, said print control apparatus comprising:
a judgment part for judging a type of a printing object;
an acquisition part for acquiring a type of paper set in each paper-feed device of said print apparatus; and
a selection part for selecting a paper-feed device to be used, based on the type of the printing object judged by said judgment part and the paper types acquired by said acquisition part.

13. A storage medium that stores a printer driver for making a computer function as a print control apparatus that controls a print apparatus provided with a plurality of paper-feed devices, wherein:
said printer driver makes the computer execute:
judgment processing for judging a type of a printing object;
acquisition processing for acquiring a type of paper set in each paper-feed device of said print apparatus; and
selection processing for selecting a paper-feed device based on the type of the printing object judged in said judgment processing and the paper types acquired in said acquisition processing.
